(19) United States
(12) Patent Application Publication
(10) Pub. No.: US 2009/0049839 A1
(43) Pub. Date: Feb. 26, 2009

(54) JET AIRCRAFT ENGINE WITH IONIZED THROUGHFLOW

(76) Inventor: Scott R. BATTLES, Liberty, MO (US)

Correspondence Address: HUSCH BLACKWELL SANDERS LLP, 4801 Main Street, Suite 1000, KANSAS CITY, MO, 64112, US

(21) Appl. No.: 12/171,405

(22) Filed: Jul. 11, 2008

Related U.S. Application Data
(60) Provisional application No. 60/959,433, filed on Jul. 13, 2007.

(51) Int. Cl. F02C 7/22

(52) U.S. Cl. 60/734; 60/772

(57) ABSTRACT

A jet aircraft engine is ionized to improve its power and efficiency. Various engine components may be electrostatically charged to form positive and negative ions causing the air and the fuel-air mixture to electrostatically accelerate from the engine intake to the exhaust.

### CROSS-REFERENCE TO RELATED APPLICATIONS

This application claims the benefit of U.S. provisional patent application Ser. No. 60/959,433 filed Jul. 13, 2007 entitled “Jet Engine Ionized Thru-flo”.

### FIELD OF THE INVENTION

This invention relates generally to aircraft engines and more particularly to a jet aircraft engine in which the air and/or fuel passing through the engine is ionized to enhance the engine performance.

### BACKGROUND OF THE INVENTION

For many years, efforts have been made to improve the performance of jet aircraft engines, especially to enhance the power and efficiency. Increased fuel efficiency has taken on even more importance due to rising jet fuel costs and potential fuel shortages. Fuel costs are known to represent a major cost factor in the operation of private, commercial and military aviation activities, including particularly air freight and commercial passenger travel. Even a small increase in fuel efficiency translates into a large cost benefit with respect to aviation activities.

In the past, efforts to enhance jet engine fuel efficiency have been focused on the design of engine components and on aeronautical enhancements. While improving hardware design and performance have been successful to some extent, the improvements have been incremental and have not offset rapidly rising fuel prices.

### SUMMARY OF THE INVENTION

The present invention is directed to a wholly different approach and the implementation of a novel technique which can have a dramatic beneficial effect on both jet engine performance and fuel efficiency. In accordance with the invention, a jet aircraft engine is subjected to ionization in a way that results in the air and/or fuel being electrostatically accelerated from the engine intake to the exhaust. The overall effect of this ionization and electrostatic acceleration is improved power and, perhaps more importantly, marked increase in the fuel efficiency.

Other and further objects of the invention, together with the features of novelty appurtenant thereto, will appear in the course of the following description.

### BRIEF DESCRIPTION OF THE SEVERAL VIEWS OF THE DRAWINGS

In the accompanying drawings, which form a part of the specification and are to be read in conjunction therewith, and in which like reference numerals are used to indicate like or similar parts in the various views:

FIG. 1 is a diagrammatic view of the present invention implemented for a low bypass turbofan jet engine; and

FIG. 2 is a diagrammatic view of the present invention implemented for a high bypass turbofan jet engine.

### DESCRIPTION OF THE PREFERRED EMBODIMENT

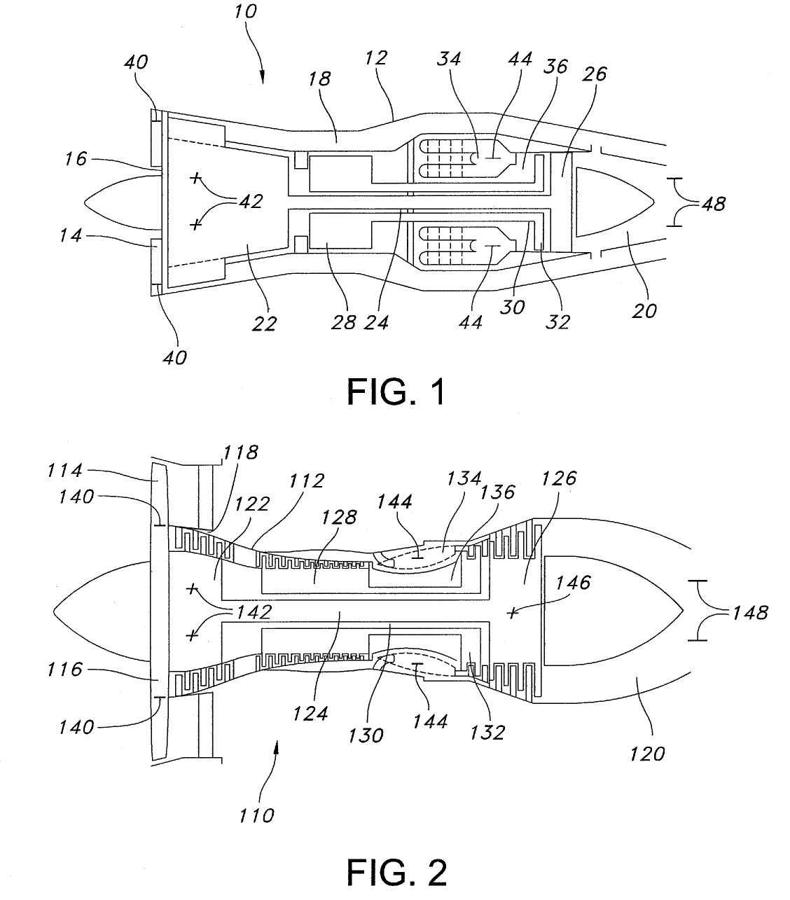

The present invention is directed to jet aircraft engines and may be implemented in connection with a low bypass turbofan jet engine which is depicted diagrammatically in FIG. 1 and generally identified by reference numeral 10. The engine 10 has an engine shroud 12 that is provided with a fan 14 for accelerating air into the intake 16 of the engine. The fan 14 directs air through a bypass duct 18 from which the air discharges in the area of a nozzle 20 at the discharge end of the engine 10.

The intake air is handled by a low pressure compressor 22 located adjacent to the intake 16. The compressor 22 compresses the air and also drives a shaft 24 which in turn drives a low pressure turbine 26. The air also encounters a high pressure compressor 28 located behind compressor 22 and operating to compress the air to a greater extent than the low pressure compressor. The high pressure compressor 28 drives a shaft 30 which in turn drives a high pressure turbine 32. The turbines 26 and 32 may be used to power various components of the engine and/or the aircraft on which the engine is mounted.

A burner 34 is provided to burn fuel which is injected into a combustion chamber 36 in which the fuel-air mixture is burned. The exhaust gases from the combustion are directed through the nozzle 20 and discharged to the atmosphere.

In accordance with the invention, the air and/or fuel that passes through the engine 10 is subjected to ionization. For example, the fan 14 may be electrostatically charged to create negative ions 40 on the ion fan. The low pressure compressor 22 may be electrostatically charged with positive ions 42. Similarly, negative ions 44 may be provided on the burner 34. The low pressure turbine 26 may be electrostatically charged with positive ions 46. Negative ions 48 may be formed in the area of the nozzle 20 by electrostatic charging techniques. It is noted that the ionization may be carried out by various techniques and at various locations on various components of the engine 10. Any or all of the internal and external parts and components of the engine may be ionized with positive or negative ions, as may the fuel, fuel additives, bypass ducts, shroud, compressors, burners, turbines and/or other parts of the engine.

The result of the ionization is that the air which enters the intake 16 is electrostatically accelerated from the intake 16 to the nozzle 20 at the discharge end of the engine, with this electrostatic acceleration dramatically increasing the engine power and the fuel efficiency. The overall effect is a significant improvement in the engine performance and a marked increase in the efficiency with which the engine 10 utilizes the jet fuel added in the combustion chamber 36.

FIG. 2 is a depiction of the present invention implemented in connection with a high bypass turbofan jet engine 110. Engine 110 has a similar construction to the low bypass turbofan engine 10 and includes similar components. Engine 110 has an engine shroud 112 and a fan 114 adjacent to the inlet 116. A relatively short bypass duct 118 is provided. At the exhaust end of the engine 110, a nozzle 120 is provided to discharge the exhaust gases to the atmosphere.

Engine 110 is equipped with a low pressure compressor 122 which drives a shaft 124. Shaft 124 in turn drives a low pressure turbine 126. A high pressure compressor 128 similarly drives a high pressure shaft 130 and a high pressure turbine 132. A burner 134 effects combustion of fuel supplied to the combustion chamber 136.

Engine 110 may be subjected to ionization in a manner similar to engine 10. The fan 114 may be electrostatically charged to provide negative ions 140. Positive ions 142 may be provided on compressor 122. The burner 134 may have negative ions 134. Positive ions 146 may be provided on turbine 126. Finally, the area of the nozzle 120 may be ionized such that negative ions 148 are present there.

The ionization of engine 110 causes the air and the air-fuel mixture passing through the engine to electrostatically accelerate from intake to exhaust in substantially the same manner as engine 10. Again, the result of this ionization and electrostatic acceleration is improved power and fuel efficiency.

The ionization of the engines 10 and 110 can be carried out using electrostatic charging techniques that are well know to those of ordinary skill in the art. Additionally, the air and/or fuel can be ionized in a variety of ways that are well known in the art. The inventor has utility for jet aircraft engines of types other than turbofan engines, including turbojet, turboprop, and turboshaft engines.

From the foregoing it will be seen that this invention is one well adapted to attain all ends and objects hereinabove set forth together with the other advantages which are obvious and which are inherent to the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative, and not in a limiting sense.

What is claimed is:

1. In a jet aircraft engine having a plurality of components, the improvement comprising at least some of said components being ionized with positive and negative ions.

2. The improvement of claim 1, wherein the engine burns fuel and wherein said fuel is ionized.

3. The improvement of claim 2, wherein air is passed through said engine and the air passing therethrough is ionized.

4. The improvement of claim 1, wherein air is passed through said engine and the air passing therethrough is ionized.

5. In a jet aircraft engine through which air is passed and in which fuel is burned, the improvement comprising means for ionizing the fuel or air.

6. The improvement of claim 5, wherein both the fuel and air are ionized.

7. The improvement of claim 5, wherein:
said engine has components for operating the engine; and
said means for ionizing the fuel or air comprises means for electrostatically charging at least some of said components.

8. A process for operating a jet aircraft engine which burns fuel, comprising ionizing the fuel.

9. A process as set forth in claim 8, wherein air is passed through the engine and including the step of ionizing the air passed through the engine.
